(19) United States
(12) Patent Application Publication
(10) Pub. No.: US 2005/0123817 A1
(43) Pub. Date: Jun. 9, 2005

(54) Micro fuel cell system

(76) Inventors: Robert Hahn, Berlin (DE); Andreas Schmitz, Freiburg (DE); Christopher Hebling, Freiburg (DE)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 10/494,546

(22) PCT Filed: Oct. 31, 2002
(86) PCT No.: PCT/EP02/12173

(30) Foreign Application Priority Data
Nov. 2, 2001 (DE) 101 55 349.8

(51) Int. Cl. H01M 8/10; H01M 8/24; H01M 4/94; B05D 5/12

(52) U.S. Cl. 429/32; 429/44; 429/38; 427/115

(57) ABSTRACT

The present invention relates to a micro cell system (1) with a membrane electrode assembly (MEA) (2) which in each case is covered on the cathode-side and anode-side with a current collector foil (3, 4). The current collector foils in each case comprise at least one gas-permeable opening (5, 6). On at least one of the current collector foils (3, 4) on a side facing the MEA (2) there are arranged diffusion channels (7, 8) These replace e.g. porous or fleece-like gas diffusion layers and thus alone ensure the micro-diffusion of gas on the MEA (2) The diffusion channels for this are connected to the gas-permeable opening (5, 6) for leading through gas, and the webs (9, 10) of the diffusion channels are provided with an electrically conductive surface (11, 12) for contacting the MEA.

The present invention relates to a micro fuel cell system according to the preamble of claim 1, as well as to a method for its manufacture, according to the claim 13.

Micro fuel cell systems are known which comprise a membrane electrode assembly which in each case on the cathode and anode side is covered with a current collector foil, wherein the current collector foils in each case comprise at least one gas-permeable opening for supplying e.g. molecular hydrogen on the anode side or for supplying air oxygen on the cathode side.

The U.S. Pat. No. 6,127,058 shows such a micro fuel cell according to the known type. In a first embodiment example which is outlined in this document, graphite papers or tissue for diffusion of introduced gases are provided between the ion-conducting polymer membrane and the current collector foils. With this, priority is given to the fact that the gases introduced through the gas-permeable opening are to be uniformly distributed onto the MEA in order thus to ensure an as good as possible efficiency of the fuel cell. However, with this several difficulties arise. In particular with very small micro fuel cells or fuel cells lying next to one another in a planar manner (as are described also in U.S. Pat. No. 6,127,058), the insertion of these diffusion layer represents a great cost burden. For the optimal functioning of the fuel cell it is specifically necessary to always align the diffusion layers onto the intended window of the MEA. A further disadvantage, in particular with methanol-operated fuel cells, is the fact on account of the diffusion layer, the fuel cell on the anode side has a higher intrinsic volume so that the fuel cell has a relatively sluggish control behaviour. It is also to be noted that in particular with gas diffusion layers which are not inserted carefully, the electrical conduction is not ensured on the whole surface so that here too reductions in the efficiency result.

It is therefore the object of the present invention to create a micro fuel cell system which on the one hand may be manufactured in a simple and economical manner and furthermore displays a very direct control behaviour also when operated with methanol.

This object with respect to the micro fuel cell system itself is achieved by claim 1, and with regard to the manufacturing method it is achieved by claim 13.

A direct distribution of gas without the intermediate arrangement of a gas diffusion layer is rendered possible by way of the fact that with a micro fuel cell system according to the invention, diffusion channels are arranged at least on one of the current collector foils on the side facing the MEA for replacing porous or fleece-like gas diffusion layers and for ensuring alone the micro-diffusion of gas on the DEA, wherein the diffusion channels are connected to the gas-permeable opening for leading through gas, and by way of providing the webs of the diffusion channels with an electrically conductive surface for contacting the DEA.

Here, the channels are distributed in such a finely incorporated manner and in such a closed channel system over the whole surface of the MEA, that no further structures are necessary for the fine distribution of gas. With this, in the present invention, an MEA is to be understood as an ion-conducing layer merely provided with a catalyser layer. At the same time the MEA has an integrated carbon fleece layer which is to effect a micro-diffusion of gas. It is completely sufficient for the MEA according to the invention to have a smooth surface so that the task of the gas diffusion is ensured alone by the diffusion channels according to the invention, which are an integral component of the current collector foils.

Apart from the task of the gas diffusion, at the same time by way of the electrically conducting web surfaces it is achieved that a low ohmic resistance exists between the current collector foil and the MEA. The ohmic resistance is not increased by a body which is sandwiched between, such as a carbon fleece diffusion layer. The distance of the channels according to the invention is selected such that on the one hand on account of the low channel widths and thus the short distance of the webs, a good collection of the current from the MEA and thus a low ohmic resistance is ascertained. On the other hand by way of the small structures, it is ensured that an adequate gas supply over the complete surface over MEA is given. At the same time the ratio of the channel widths to the web widths is selected such that the ohmic losses are less that one percent on transition from the MEA to the current collector layer.

The invention is particularly advantageous for methanol-operated fuel cell systems, since here there exists no volume-increasing buffer zone by way of a gas diffusion layer. The intrinsic volume given in the system may be designed very small on the anode side. At the same time, in particular for methanol-operated fuel cells, there results a direct control behaviour (i.e. in methanol operation (DMFC) on reducing the load, lower losses occur due to the passage of methanol since the storage volume is limited, and thus a more favourable dynamic behaviour and a greater efficiency results).

Advantageous formations of the present invention are shown in the dependent claims.

A particularly advantageous embodiment envisages the micro fuel cell system according to the invention consisting of several fuel cells arranged next to one another, wherein these are electrically connected to one another. Here the full worth of the invention may be seen since with many small-dimensioned micro fuel cells lying next to one another, the attachment of separate gas diffusion layers represents and expensive measure which creates errors. With the construction according to the invention it is however possible to align essentially only three elements (i.e. the two current collector foils and the MEA) to one another at their edges and to lay these on one another (here one may fall back on the method of the semiconductor industry or the manufacture of electronics/circuit boards). At the same time an automatic manufacture lends itself, wherein one may fall back on the manufacturing methods of the semiconductor industry. At the same time it has further been shown that with series connected micro fuel cells, it lends itself to not only connect these to one another via one contact surface. A connection via several contact surfaces which are arranged on points of the fuel cell which in each case are distanced far from one another effects a drastic reduction of the ohmic resistance.

A further advantageous further formation of the invention envisages the width of the diffusion channels, i.e. the distance measure at the widest location of the channel which is regularly give at the border to the MEA, to be between 1 and 300 μm, preferably between 10 and 100 μm. At the same time it has shown to be particularly advantageous for the channels to be designed in a meandering manner, wherein proceeding from a gas-permeable opening introducing gas, the channel becomes smaller with an increasing distance to this opening. This minimises the pressure drop across the path so that at all locations of the channel roughly equal quantities of gas may be given to the MEA.

A further advantageous embodiment envisages the current collector foils to comprise a polymer layer (quasi as a “skeleton”). Recesses may be manufactured in this polymer layer in an economical manner by way of laser processing, wet-etching, reactive ion-etching or likewise. After the manufacture of these recesses a corrosion-resistant and low-resistance tapping of current is possible by way of metallising with conductive metals such as gold, which have a particularly good conductivity. It is of course however also possible to deposit the conductive metal structures onto a smooth polymer layer and thus to produce the channels between the conductive structures. Furthermore a further reduction of the manufacturing costs is possible, by providing e.g. a pre-punched metal structure instead e.g. of a metal structure which has been vapour-deposited.

One further advantageous embodiment envisages providing elements for water management of the fuel cell in the region of the channel structures or the MEA. This on the one hand may be effected by arranging porous components for the retention of the reduction water in the region of the MEA. By way of this, on the one hand excess reaction water is suctioned off and on the other hand a drying-out of the MEA is prevented over the longer term so that simpler start of the fuel cell is given. For an even more targeted leading of the water it is also possible e.g. to connect the channel inner walls (not the web tips which are to be connected to the MEA in an electrically conductive manner) to a hydrophilic or hydrophobic substance (like Nafion or Teflon). The MEA in regions may just as well be impregnated for repelling dirt and water, at least in regions.

Further advantageous embodiments of the present invention are specified in the remaining claims.

The present invention is now explained by way of several figures. There are shown in:

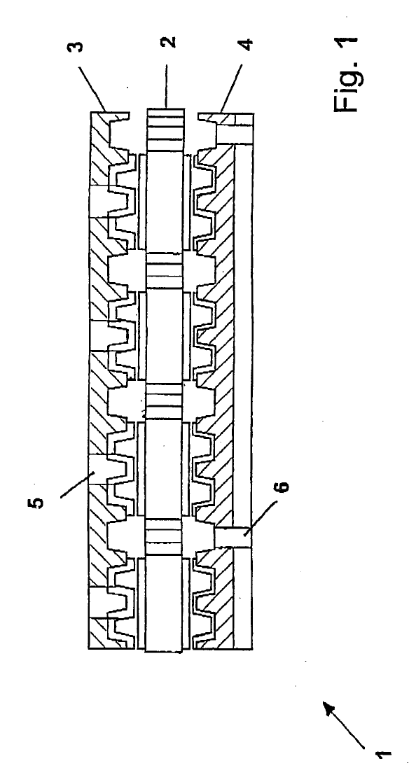

FIG. 1 a cross section through a micro fuel cell system according to the invention,

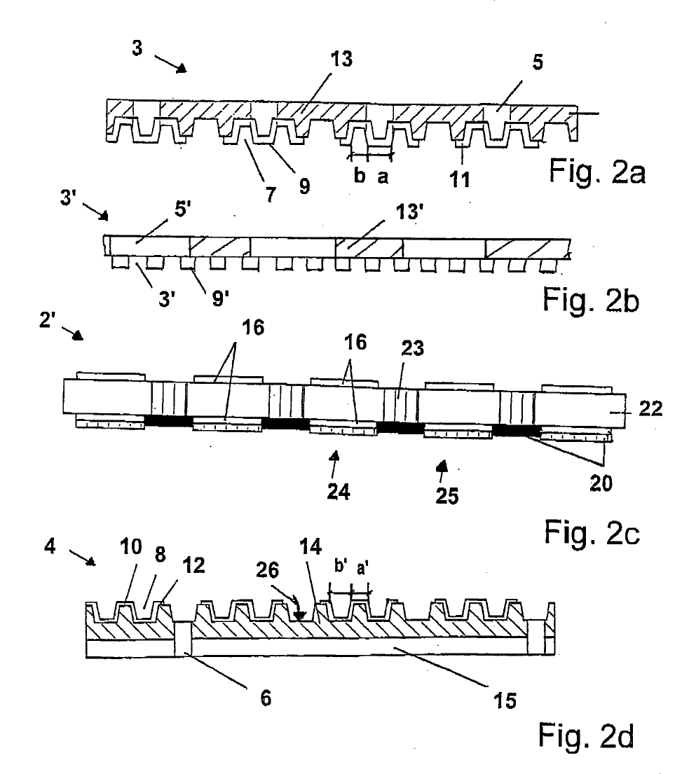

FIGS. 2a and 2b two embodiments of a cathode-side current collector foil according to the invention,

FIG. 2c an MEA according to the invention,

FIG. 2d one embodiment of an anode-side current collector foil,

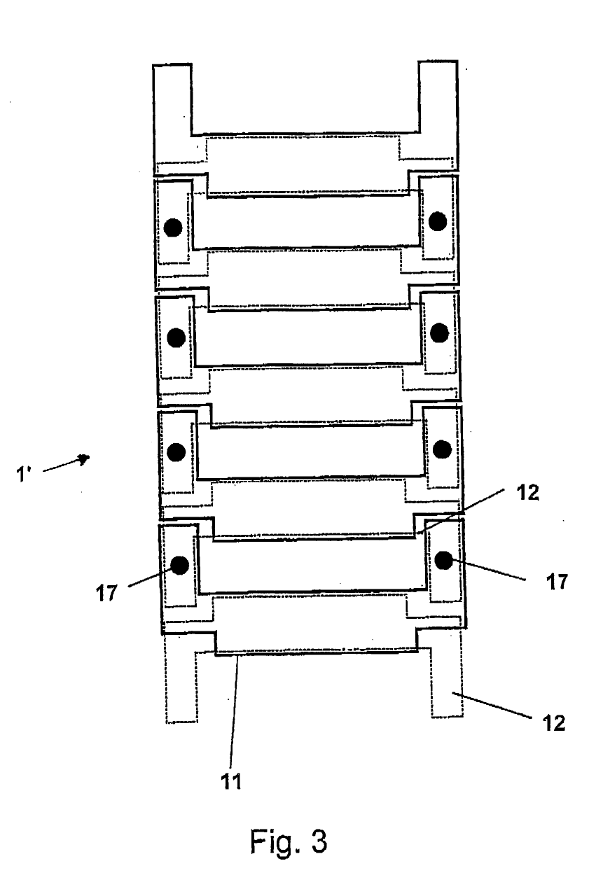

FIG. 3 a plan view of a micro fuel cell system according to the invention,

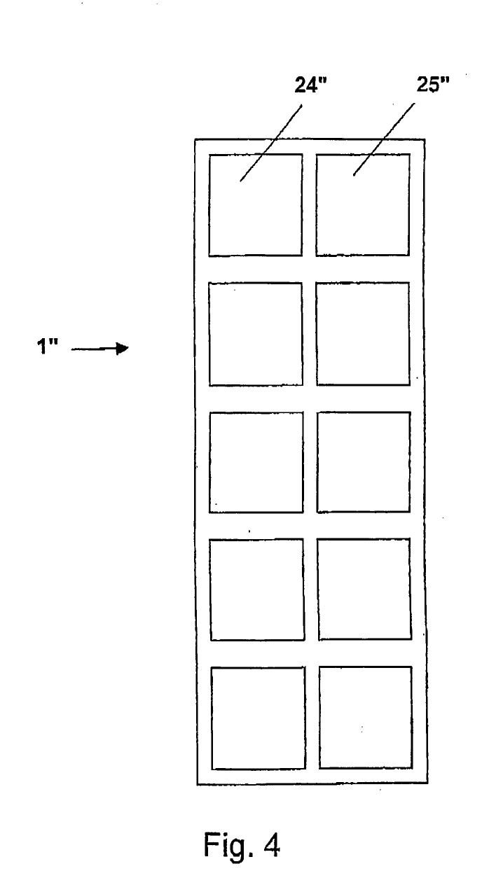

FIG. 4 a further embodiment of a micro fuel cell system according to the invention, in a plan view,

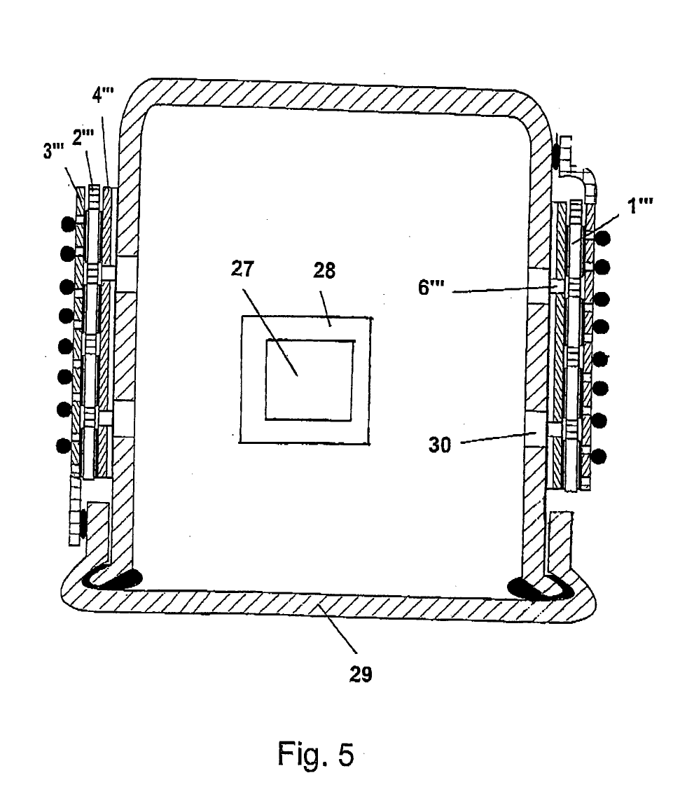

FIG. 5 a micro fuel cell system according to the invention, in the assembled condition.

FIG. 1 shows a micro fuel cell system 1 according to the invention. With this it is the case of a micro fuel cell system with a membrane electrode assembly (MEA) 2, which is covered on the cathode-side and anode-side with a current collector foil 3 and 4 respectively. The current collector foils 3 and 4 comprise several openings 5 and 6 respectively. Molecular hydrogen (in other embodiments a methanol operation is also possible) may be supplied on the anode side through these openings 6. Furthermore a second opening for leading away excess hydrogen from the anode space is also provided. The current collector foils 3 and 4 in each case on their side facing the MEA have diffusion channels or channel systems which replace gas diffusion layers and thus alone ensure the micro-diffusion of gas on the MEA. The diffusion channels are connected in each case to the openings 5 and 6 and the tips or webs of the diffusion channels are in each case in contact with the electrode surfaces of the MEA.

In the following, the individual components for the micro fuel cell shown in FIG. 1 are explained in detail.

FIG. 2a shows the cathode-side current collector foil 3. This comprises a polymer layer 13. The polymer laser 13 comprises a plurality of openings 15. On the cathode side several operating manners are possible, depending on the number of these holes. On the one hand with the provision of a few holes a supply preferably with pressurised air (as on the anode side) is possible. With a multitude of openings one may also realise fuel cells which breathe air (see below, FIG. 2b). The current collector foil comprises diffusion channels 7 which are metallically coated (instead of such a metallic coating it is also possible in all embodiments to provide an electrically conductive layer of the material). The recesses in the polymer layer 13 on which these metallisations 11 are built up have been manufactured for example by layer processing, wet-etching, reactive ion-etching or likewise. The electrically conductive surfaces of the diffusion channels 7 have been deposited onto these recesses. This deposition may be effected by sputtering, vapour-deposition, galvanic methods, seed crystallisation or precipitation without current. It is important that the webs 9 of the channels which are later connected to the electrodes 16 of the MEA are coated with an electrically highly conductive layer 11, e.g. of gold. The width b of the diffusion channels 7 at the same time is between 1 and 300 μm, preferably between 10 and 100 μm. This distance, as shown in FIG. 2a, is measured between the corner points lying closest to the MEA. In a preferred embodiment, the diffusion channels 7 are shaped in a meandering manner, wherein in the longitudinal direction of the channel (i.e. perpendicular to the plane of the sheet) this becomes narrower with an increasing distance, for minimising the pressure drop in the system. It is thus possible for the channel beginning with a width of a few 100 μm to finally end with a remaining width of 10 μm.

It is also yet to be mentioned that the metallisation 11 on the diffusion channel surface is not continuous over the complete polymer layer towards the MEA, but is only effected in regions, and specifically in the regions congruent with the electrodes 16 of the MEA. For water management in the micro fuel cell system it is possible to provide in particular the inner flanks of the metallisation 11 (thus not in the regions of the webs) with a hydrophilic or hydrophobic layer, e.g. of Nafion or Teflon in order to prevent a water accumulation at these locations and thus a blockage of the channel (which of the recesses lying next to one another which in each case are commonly coated with the metallisation 11).

FIG. 2b shows a further embodiment of a current collector foil according to the invention, a current collector foil 3′. This is designed as an essentially smooth polymer layer 13′ in which large-volumed openings 5′ are incorporated. A continuous net-like metal mask 5 is attached on the side of the polymer layer 13′ which faces the MEA. This metal mask ensures that a homogenous current collection is possible everywhere on the cathode and this is not interrupted by holes 5′. The current collector foil 3′ is “self-breathing”, i.e. the openings 5′ are connected to the surrounding air and thus the fuel cell system covers its oxygen requirement from the surrounding air.

FIG. 2c shows an MEA 2′ which represents a modification of the MEA 2 of FIG. 1. This comprises a base structure in the form of a proton-conducting polymer membrane 22 in which insulating regions are provided, i.e. regions 23 which are unsuitable for the transport of protons and water molecules. The manufacture of these insulating regions from the polymer membrane which as a whole is proton-conductive is possible by way of laser-temperature treatment, by thermo-compression with a punch tool or e.g. by way of a special coating or impregnation. The insulating layer 23 separates two individual micro fuel cells 24 and 25 from one another. The individual fuel cells in each case comprise electrodes 16 in the direction of the current collector foils 3 and 4, which consist of an essentially non-porous catalyser layer. I.e. a large-surfaced gas distribution within these electrodes 16 is possible not due to e.g. an intrinsic porosity of the catalyser layer. The task of gas diffusion is assumed by the diffusion channels of the current collector foils alone. The electrodes 16 of the micro fuel cells 24 and 25 lying next to one another, which are designed as catalyser layers in each case on one side of the MEA are not electrically connected to one another. The manufacture of such an MEA at the same time may either be effected such that already on manufacture, a catalyser layer for producing the electrodes 16 is created only in regions. Alternatively it is also possible to electrically insulate a polymer membrane coated continuously with a catalyser layer in regions, for example by way of mechanical processing or reactive ion etching in this region.

On the anode side of the MEA 2′ this is additionally provided with further layers. These are designed such that although they conduct water and ions, they however do not let through methanol. In alternative embodiments it is possible to design the catalyser layer itself also as a methanol barrier, i.e. that this thus has a combined task (catalyser, electrode as well as methanol barrier). For improving the water management in the region of the MEA, one may also insert porous components for the retention of reaction water on the cathode side between the current collector foil and the MEA. It is furthermore also possible to impregnate the free-lying electrode surface 16 at least in regions, for repelling dirt and water.

FIG. 2d shows a current collector foil 4 on the anode side. With regard to the diffusion channels 8, the webs 10, the electrically conductive surface/metallisation 12 as well as the width measures b′ and a′ and the polymer layer 14, all that which has been discussed above for the cathode side applies, inasmuch as in the following the contrary is stated. The current collector foil 4 on the anode side comprises only two openings 6 which serve for the introduction of a reaction medium or for the exit of excess reaction medium. Advantageously molecular hydrogen or methanol are considered as reaction media. In particular with the use of methanol, there exists the advantage that the intrinsic volume of the micro fuel cell in the anode space is significantly reduced in comparison to micro fuel cells with an inserted gas diffusion layer. The current collector foil 4 on its side which is distant to the MEA comprises a metal mask 15. Hydrogen present within the anode space may not escape through the polymer layer 14 in the direction 26, the metal foil/coating here serves as a diffusion blocker.

Methods known from semiconductor manufacturing technology and circuit board technology may be used for the manufacture of the current collector foil 4 (this also applies to the current collector foil 3). It is thus possible that a polymer plate which is plane on both sides (from which the polymer layer 14 proceeds by way of a later machining/processing), before its machining/processing is adhered (bonded) on a metal mask 15 located on a wafer and after the manufacture of the recesses for the channels 8 or depositing the electrically conductive layers/metallisations 12, the wafer is removed again. An inexpensive manufacture in a larger batch number is however also possible by way of a roll process (roller to roller). Finally the final incorporation of the openings 6 onto the current collector foil is possible by way of laser drilling or water jet drilling procedures or reactive ion etching or by way of mechanical methods.

The manufacture of the finished micro fuel cell system 1 from the components shown in the FIGS. 2a to 2d is then finally effected by way of adhering (bonding) or pressing the current collector foils on the MEA. At the same time, in particular the anode-side current collector foil 4 with the webs 10 is deposited directly onto the MEA 2. The pressure of the current collector foils on the MEA necessary for the perfect functioning of the micro fuel cell system is however also possible by way of pressing this coating on arcuate surfaces. At the same time the flexibility of the layers according to the invention may be exploited (see also FIG. 5).

FIG. 3 in a plan view shows a micro fuel cell system 1′ according to the invention. With this the U-shaped edged regions with continuous lines represent the metallisations 11 on the cathode-side current collector foil 3. The dashed U-shaped regions show the metallised regions 12 of the anode-side current collector foil 4. FIG. 3 shows a plan view, i.e. that the cathode side, as shown in FIG. 1, lies above the MEA and the anode side below the MEA. Both metallisations are connected to one another via contact points 17 so that in FIG. 3 one may recognise a series connection of the micro fuel cells lying next to one another.

FIG. 4 shows a further embodiment of a micro fuel cell system according to the invention in a schematic form. Here one may recognise that not only is a simple, one-dimensional series connection of the micro fuel cells possible (here e.g. 24″ and 25″), but also a two-dimensional arrangement.

FIG. 5 shows a further embodiment of a micro fuel cell system 1″′ according to the invention. With this, an essentially cylindrical receptacle 29 is shown. A fuel tank, e.g. for molecular hydrogen 27 is shown within this receptacle 29. A control means 28 is arranged around this fuel tank 27 and controls the gas flow from the fuel tank 27 through the openings 30 to the fuel cell 1′″ wound around the cylinder 29 according to a control means which has not been shown. The fuel cell 1′″ in its construction corresponds essentially to that shown in FIG. 1. The micro fuel cell system 1′″ is tensioned around the receptacle 29 such that the two current collector foils 3″′ and 4″′ exert the desire pressure onto the MEA 2″′ which lies therebetween. The openings 6″′ of the current collector foil 4″′ on the anode side at the same time are connected to the openings 30 in the receptacle 29 for supplying fuel. The cathode-side current collector foil 3″′ is designed in an “air-breathing” manner. With this construction form in particular, it is clear that small-dimensioned and flexible fuel cell systems are possible with the micro fuel cell system according to the invention.

There are yet further embodiment forms for manufacturing the micro fuel cell system according to the invention.

Thus the current collector foil with channel structures and openings may be manufactured with a wafer onto which a sacrificial layer/sacrificial structure has been deposited. After completion, the sacrificial layer may be removed here, and in this manner a self-supporting current collector foil (e.g. reference numerals 3 and 4 in FIG. 1) arises.

Thus a method for manufacturing a micro fuel cell system is also known, wherein firstly a sacrificial structure is deposited onto the MEA, onto which further layers are deposited for forming the current collector foil by way of direct precipitation and structuring methods, and subsequently the sacrificial structure is removed for freeing diffusion channels or likewise.

This method may be applied to the anode side as well as to the cathode side. It is possible to manufacture only one side with this manufacturing method and to manufacture the other side with another of the methods mentioned above. It is particularly advantageous for the electrical contact between these components to also be able to be manufactured without the mechanical pressing of already finished current collector foils onto the MEA.

With this, e.g. the MEA foil is firstly structurised and then fastened on a wafer by way of a sacrificial layer/sacrificial structure. After this the channel structures and openings are additively deposited by way of lithography, sputtering, galvanic, screen printing or likewise, as well as with the help of further sacrificial layers, so that the current collector structure and gas distribution structure (3 or 4 in FIG. 1) is directly connected to the MEA by manufacture. Thereafter the sacrificial layer is removed, and the foil (in this case now 2 and 3 or 2 and 4, FIG. 1) is connected to the other side of the wafer and the structures (3 and 4) of the other side are created.

The main advantage of this manufacture is the fact that no mechanical pressing pressure is necessary for achieving a small contact resistance. By way of the direct sputtering-on, vapour-deposition, chemically galvanic precipitation or printing-out a good adherence (bonding) to the MEA surface and a low contact resistance as well as a good sealing of the media is created. With the help of structurised sacrificial layers which are subsequently removed, on may also manufacture channels which above all are required on the anode side. This method may also be used for only one side (3 or 4, FIG. 1) whilst the other side is manufactured as previously described.

1. A micro fuel cell system having a membrane electrode assembly (MEA) including a cathode-side and an anode-side, a current collector foil covering each side of the MEA, each of the current collector foils including at least one gas-permeable opening at least one of the current collector foils having diffusion channels on the side facing the MEA for replacing gas diffusion layers and for ensuring alone the micro-diffusion of gas on the MEA, wherein the diffusion channels are connected to the gas-permeable opening for leading through gas, and the diffusion channels having webs provided with an electrically conductive surface for contacting the MEA, the current collector foils comprising a polymer layer incorporating on the side facing the MEA the diffusion channels, wherein the webs of the channels are metallised.

2. A micro fuel cell system according to claim 1, wherein the width of the diffusion channels is between 1 and 300 μm.

3. A micro fuel cell system according to claim 1 or 2 wherein the diffusion channels are designed in a meander-like manner, wherein proceeding from a gas-conducting, gas-permeable opening each diffusion channel becoming narrower with an increasing distance from the gas-permeable opening, for minimising the pressure drop in the system.

4. A micro fuel cell system according to claim 1, further comprising a metal mask is attached on that side of the polymer layer remote from the MEA.

5. A micro fuel cell system according to claim 1 further comprising porous components for the retention of reaction water are arranged in the region of the MEA.

6. A micro fuel cell system according to claim 1 further comprising a supply of molecular hydrogen or methanol as a fuel.

7. A micro fuel cell system according to claim 1 further comprising several similar fuel cells located next to one another in a planar manner that are connected electrically.

8. A micro fuel cell system according to claim 1 wherein the cathode side of the current collector foil includes a multitude of openings for supplying the cathode with air oxygen.

9. A micro fuel cell system according to claim 8, wherein the free-lying electrode surface is impregnated at least in regions for repelling dirt and/or water.

10. A micro fuel cell system according to claim 7, wherein an anode-side current collector foil of one of the similar fuel cells is connected to the cathode-side current collector foil of an adjacent fuel cell at at least two points.

11. A micro fuel cell system according to claim 1 wherein the recited components of the micro fuel cell are flexible and conform to a surface of a receptacle for storing fuel.

12. A method for manufacturing a micro fuel cell system comprising the steps of: depositing at least the anode-side current defector foil (4) with the webs is deposited directly onto an MEA, wherein for manufacturing a current collector foil, recesses for the diffusion channels are manufactured by way of laser treatment, wet etching, reactive ion etching or mechanical methods such as embossing, pressing, punching or likewise, and the polymer plate before its processing (machining) is deposited onto a metal foil located on a wafer, and after manufacture of the recesses and/or deposition of the electrically conductive layers, the wafer is removed again or that this is effected in roller processes, or firstly a sacrificial layer/sacrificial structure is deposited on a wafer and after completion of the current collector foils, the sacrificial layer/sacrificial structure is removed for creating a self-supporting current collector foil.

13. A method according to claim 12, wherein the deposition is effected by adhering (bonding) and/or pressing.

14. A method according to claim 12 or 13 wherein before depositing the current collector foils onto the MEA, in regions, electrically insulating regions for the insulation of cells lying next to one another are created in the MEA.

15. A method according to claim 12 or 13 wherein before depositing the anode-side current collector foil (4), a methanol barrier layer (20) belonging to the MEA (2) is deposited.

16. A method according to claim 13, characterised in that the diffusion channels are produced by depositing metal structures on an essentially plane polymer plate.

17. A method according to claim 12 or 13 wherein finally openings (5, 6) are incorporated into the current collector foil (3, 4) by way of laser jet or water jet drilling or reactive ion etching or mechanical methods.

18. A method for the manufacture of a micro fuel cell system according to claim 12 or 13 wherein firstly a sacrificial structure is deposited onto the MEA, onto which further layers are deposited by direct precipitation or structurisation methods, for forming the current collector foil, and subsequently the sacrificial structure is removed for clearing diffusion channels or likewise.

19. A method for manufacturing a current collector foil for use in a micro fuel cell system comprising the steps of manufacturing the current collector foil (3, 4) recesses for the diffusion channels (7, 8) by way of laser treatment, wet etching, reactive ion etching or mechanical methods such as embossing, pressing, punching or likewise and the polymer plate before its processing is deposited onto a metal foil located on a wafer, and after manufacture of the recess and/or deposition of the electrically conductive layers the wafer is removed again, or this is effected in roller processes, or firstly a sacrificial layer/sacrificial structure is deposited on a wafer and after completion of the current collector foils, the sacrificial layer/sacrificial structure is removed for creating a self-supporting current collector foil.

20. A current collector foil, manufactured according to claim 19.

21. A micro fuel cell system according to claim 2, wherein the width of the diffusion channels is between 10 and 100 μm.
